(19) United States
(12) Patent Application Publication
(10) Pub. No.: US 2025/0267366 A1
(43) Pub. Date: Aug. 21, 2025

(54) POSITION CONTROL DEVICE, SHAKE CORRECTION DEVICE, AND OPTICAL DEVICE

(71) Applicant: FUJIFILM Corporation, Tokyo (JP)

(72) Inventors: Yu MOCHIZUKI, Saitama-shi (JP); Yuta ABE, Saitama-shi (JP); Kouhei AWAZU, Saitama-shi (JP)

(73) Assignee: FUJIFILM Corporation, Tokyo (JP)

(21) Appl. No.: 19/023,281

(22) Filed: Jan. 16, 2025

(30) Foreign Application Priority Data
Feb. 16, 2024 (JP) 2024-021953

(51) Int. Cl. H04N 23/68; G02B 27/64; H04N 23/54; H04N 23/55

(52) U.S. Cl. CPC H04N 23/687; H04N 23/54; H04N 23/6812; G02B 27/646; H04N 23/55

(57) ABSTRACT

Provided are a position control device, a shake correction device, and an optical device capable of improving linearity characteristics and obtaining a large driving force. A shake correction device employs a double magnet configuration including a yoke having a first magnet and a second magnet, a yoke having a third magnet and a fourth magnet, and a moving portion that holds an FPC substrate to which a coil and a Hall element are mounted, in which the Hall element is disposed inside the coil, and a mounting surface of the Hall element is provided at a position between a first edge surface and a second edge surface facing each other in a height direction which is a direction of the coil.

### CROSS-REFERENCE TO RELATED APPLICATION

The present application claims priority under 35 U.S.C § 119(a) to Japanese Patent Application No. 2024-021953 filed on Feb. 16, 2024, which is hereby expressly incorporated by reference, in its entirety, into the present application.

### BACKGROUND OF THE INVENTION

### 1. Field of the Invention

The present invention relates to a position control device, a shake correction device, and an optical device for performing image shake correction.

### 2. Description of the Related Art

JP2020-197630A discloses a stage device comprising a fixed portion, a movable portion that is movable with respect to the fixed portion, a driving force generation unit, and a magnetic field detection unit. The driving force generation unit includes a first magnet portion composed of a first magnet and a second magnet, a second magnet portion composed of a third magnet and a fourth magnet, and a coil disposed between the first magnet portion and the second magnet portion, and the magnetic field detection unit is disposed between the first magnet portion and the second magnet portion.

### SUMMARY OF THE INVENTION

One embodiment according to the technology of the present disclosure provides a position control device, a shake correction device, and an optical device that correct an image shake by moving a moving portion having a holding member that holds an imaging element or an optical element.

According to a first aspect of the present invention, there is provided a position control device comprises a fixed portion that includes a first yoke, a first magnet and a second magnet which are provided on the first yoke and are disposed with a first width, a second yoke that is disposed to face the first yoke, and a third magnet and a fourth magnet which are provided on the second yoke and are disposed with a second width, and a moving portion that is disposed between the first yoke and the second yoke and has a substrate on which a coil and a position detection sensor are mounted, in which the position detection sensor is disposed inside the coil and has a mounting surface of the position detection sensor at a position between a first edge surface and a second edge surface that face each other in a height direction of the coil.

According to a second aspect of the present invention, in the position control device according to the first aspect, the position detection sensor is mounted to a height adjustment portion of which a height from the substrate is adjusted.

According to a third aspect of the present invention, a position control device comprises a support member that supports the height adjustment portion in the second aspect.

According to a fourth aspect of the present invention, in the position control device according to the third aspect, the support member is a coil bobbin of the coil.

According to a fifth aspect of the present invention, in the position control device according to the first aspect, the coil may include a first coil disposed on a first surface and a second coil disposed on a second surface, the first surface and the second surface facing each other in a thickness direction of the substrate, and the position detection sensor may be mounted to the first surface or the second surface.

According to a sixth aspect of the present invention, there is provided a position control device according to the fifth aspect further comprises an electronic circuit that outputs a first control signal and a second control signal, which are phase-shifted from each other at a predetermined frequency to the first coil and the second coil.

According to a seventh aspect of the present invention, in the position control device according to the sixth aspect, the first control signal and the second control signal are PWM control signals.

According to an eighth aspect of the present invention, in the position control device according to any one of the fifth to seventh aspects, in a case where the position detection sensor is mounted to the first surface, an inner diameter of the second coil is smaller than an inner diameter of the first coil.

According to a ninth aspect of the present invention, in the position control device according to any one of the first to eighth aspects, the first width and the second width are different from each other.

According to a tenth aspect of the present invention, there is provided a shake correction device, in which the position control device according to any one of the first to ninth aspects is a shake correction device, the moving portion includes a holding member, and the holding member holds an imaging element or an optical element.

According to an eleventh aspect of the present invention, there is provided an optical device comprises the shake correction device according to the tenth aspect.

### BRIEF DESCRIPTION OF THE DRAWINGS

FIG. 1 is a front view of a shake correction device of the present embodiment as viewed from a front surface side.

FIG. 2 is a functional block diagram of the shake correction device of FIG. 1.

FIG. 3 is a cross-sectional view taken along the line III-III of FIG. 1.

FIG. 4 is an explanatory diagram showing a substrate configuration which is a raised configuration of a Hall element.

FIG. 5 is an explanatory diagram showing a VCM having a one-side configuration.

FIG. 6 is an explanatory diagram showing a VCM having a double magnet configuration.

FIG. 7 is an explanatory diagram in which a coil having a high height is applied instead of the coil of FIG. 5.

FIG. 8 is an explanatory diagram showing another example of the raised configuration of the Hall element.

FIGS. 9A and 9B are explanatory diagrams showing another example of the raised configuration of the Hall element.

FIG. 10 is an explanatory diagram showing another example of the raised configuration of the Hall element.

FIGS. 11A and 11B are explanatory diagrams showing another example of the raised configuration of the Hall element.

FIGS. 12A and 12B are explanatory diagrams in which the Hall element is mounted using a coil bobbin.

FIG. 13 is a diagram showing a first modification example of the shake correction device.

FIG. 14 is a diagram showing a second modification example of the shake correction device.

FIG. 15 is a graph showing a relationship between a double magnet configuration and linearity characteristics.

### DESCRIPTION OF THE PREFERRED EMBODIMENTS

Hereinafter, an embodiment of the present invention will be described with reference to the drawings.

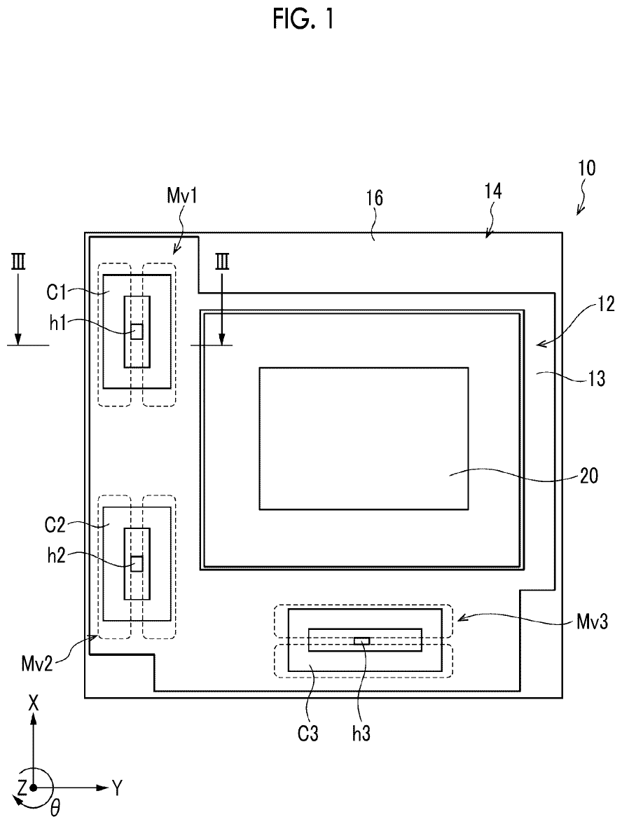

FIG. 1 is an explanatory diagram showing a schematic configuration of a shake correction device 10 of the present embodiment, and is a view of the shake correction device 10 as viewed from a front surface side (subject side). The shake correction device 10 is mounted on a digital camera and corrects an image shake caused by vibration occurring in the digital camera. The shake correction device 10 is an example of a position control device and a shake correction device according to the embodiment of the present invention.

In brief, a digital camera (hereinafter, abbreviated as a “camera”) comprises a camera body and a lens portion provided in the camera body. The shake correction device 10 of the present embodiment is mounted on the camera body. The camera may be a lens-interchangeable camera in which a lens portion is attachable to and detachable from a camera body, or may be a lens-integrated camera. The camera is an example of the optical device according to the embodiment of the present invention.

As shown in FIG. 1, the shake correction device 10 comprises a moving portion 12 and a fixed portion 14 that movably supports the moving portion 12. The moving portion 12 and the fixed portion 14 are examples of a moving portion and a fixed portion of the present invention.

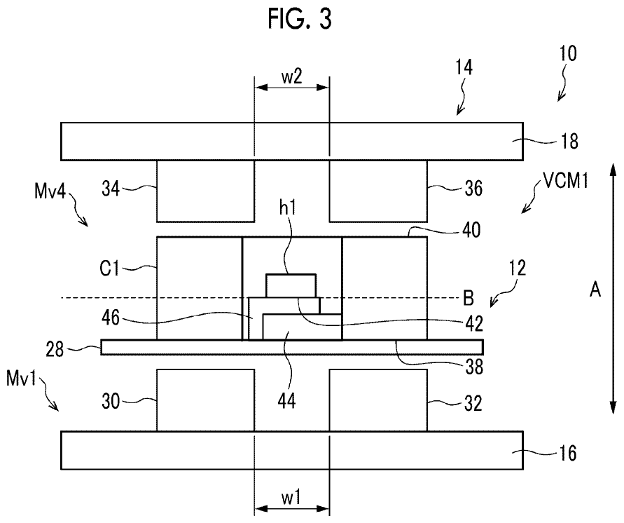

The moving portion 12 comprises a holding member 13 that holds the imaging element 20. The holding member 13 is an example of a holding member according to the embodiment of the present invention. The fixed portion 14 has a yoke 16 and a yoke 18 (see FIG. 3). The yoke 16 and the yoke 18 are each an example of a first yoke and a second yoke of the embodiment of the present invention.

The imaging element 20 images a subject through an imaging optical system provided in a lens portion. The imaging element 20 has a semiconductor chip on which a complementary metal oxide semiconductor (CMOS) image sensor, a charge coupled device (CCD) image sensor, or the like is formed, and a package that accommodates the semiconductor chip. The imaging element 20 is an example of an imaging element according to the embodiment of the present invention.

The fixed portion 14 is fixed to the camera body. The fixed portion 14 supports the moving portion 12 to be movable in a plane intersecting an optical axis of the imaging element 20. In the present embodiment, the moving portion 12 is supported to be movable in a plane orthogonal to the optical axis of the imaging element 20. The expression “a plane being orthogonal to the optical axis” described above also means a plane that can be counted as being substantially orthogonal to the optical axis.

The shake correction device 10 corrects an image shake of a captured image captured by the imaging element 20 by moving a light-receiving surface of the imaging element 20 in a plane orthogonal to an optical axis of the imaging element 20. The optical axis of the imaging element 20 is a virtual straight line that passes through the center of the light-receiving surface of the imaging element 20 and is orthogonal to the light-receiving surface.

The shake correction device 10 corrects the image shake by moving the moving portion 12 with respect to the fixed portion 14 in three directions of an X direction which is a lateral direction of a light-receiving surface of the imaging element 20, a Y direction which is a longitudinal direction of the light-receiving surface, and a θ direction which is a direction around the optical axis (a rotation direction around the optical axis).

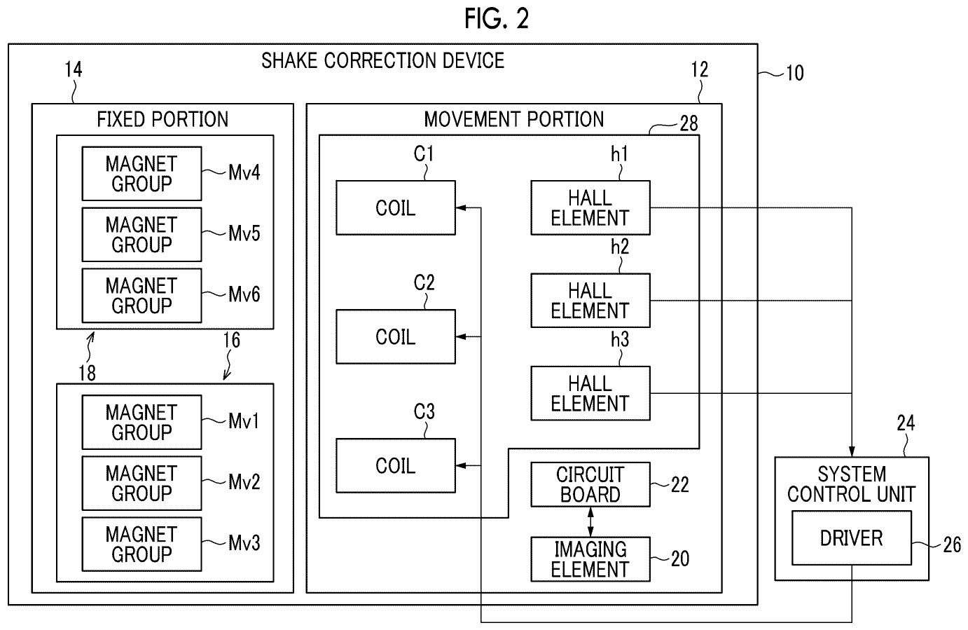

FIG. 2 is a functional block diagram showing a schematic configuration of the shake correction device 10 shown in FIG. 1.

As shown in FIG. 2, the shake correction device 10 comprises a moving portion 12 that is movable in three directions of X, Y, and θ directions, and a fixed portion 14 that supports the moving portion 12 to be movable in the three directions.

The moving portion 12 includes a circuit board 22 to which the imaging element 20 is mounted, a coil C1 for X-axis rotation drive, a coil C2 for X-axis rotation drive, and a coil C3 for Y-axis drive. The coils C1, C2, and C3 are examples of the coil according to the embodiment of the present invention.

In addition, the moving portion 12 includes Hall elements h1, h2, and h3. The Hall elements h1, h2, and h3 are examples of the position detection sensor according to the embodiment of the present invention. Output signals of the Hall elements h1, h2, and h3 are input to the system control unit 24 of the camera. The system control unit 24 includes a driver 26. The driver 26 is an example of an electronic circuit.

The system control unit 24 controls each of pulse width modulation (PWM) control signals output from the driver 26 to the coils C1, C2, and C3 based on the output signals from the Hall elements h1, h2, and h3. As a result, the moving portion 12 moves in a direction of correcting the image shake, and the image shake is corrected.

The coils C1, C2, and C3 and the Hall elements h1, h2, and h3 are mounted to a flexible printed circuit (FPC) substrate 28. The FPC substrate 28 is mounted to the holding member 13 of the moving portion 12. The FPC substrate 28 is an example of a substrate according to the embodiment of the present invention.

The fixed portion 14 includes two yokes 16 and 18. In the shake correction device 10, the yoke 16 is disposed on the rear surface side (imaging person side), and the yoke 18 is disposed on the front side (subject side). In addition, the yoke 16 and the yoke 18 are disposed to face each other with the moving portion 12 interposed therebetween in a direction parallel to the optical axis direction of the imaging element 20. In a state where the moving portion 12 is interposed between the yoke 16 and the yoke 18, the yoke 16 and the yoke 18 are fixed to each other by screwing with a plurality of screws. The expression “a direction parallel to the optical axis direction” described above also means a plane that can be counted as being substantially parallel to the optical axis direction. In addition, in FIG. 1, the yoke 18 is not shown.

As shown in FIG. 2, the yoke 16 has a magnet group Mv1 for X-axis rotation drive, a magnet group Mv2 for X-axis rotation drive, and a magnet group Mv3 for Y-axis drive.

The yoke 18 has a magnet group Mv4 for X-axis rotation drive, a magnet group Mv5 for X-axis rotation drive, and a magnet group Mv6 for Y-axis drive.

Each of the three magnet groups Mv1, Mv2, and Mv3 and the magnet groups Mv4, Mv5, and Mv6 are disposed to face each other in a direction parallel to the optical axis of the imaging element 20. The expression “a direction parallel to the optical axis” described above also means a plane that can be counted as being substantially parallel to the optical axis.

FIG. 3 is an explanatory diagram showing a disposition configuration (the former disposition configuration) of the two magnet groups Mv1 and Mv4, the coil C1, and the Hall element h1 in a cross section taken along the line III-III of FIG. 1. The two magnet groups Mv1 and Mv4, the coil C1, and the Hall element h1 are disposed along the A direction parallel to the optical axis direction of the imaging element 20. The expression “a direction parallel to the optical axis direction” described above also means a plane that can be counted as being substantially parallel to the optical axis direction.

It should be noted that the disposition configuration (the latter disposition configuration) of the two magnet groups Mv2 and Mv5, the coil C2, and the Hall element h2 and the disposition configuration (the latter disposition configuration) of the two magnet groups Mv3 and Mv6, the coil C3, and the Hall element h3 are the same as the former disposition configuration. Therefore, the former disposition configuration will be described here, and the latter two disposition configurations will not be described.

As shown in FIG. 3, the shake correction device 10 of the present embodiment comprises a moving portion 12 and a fixed portion 14.

The fixed portion 14 includes a yoke 16, a first magnet 30 and a second magnet 32 that are provided on the yoke 16 and are disposed with a first width w1, a yoke 18 that is disposed to face the yoke 16, and a third magnet 34 and a fourth magnet 36 that are provided on the yoke 18 and are disposed with a second width w2.

The moving portion 12 has an FPC substrate 28 that is disposed between the yoke 16 and the yoke 18 and on which the coil C1 and the Hall element h1 are mounted.

The first magnet 30 and the second magnet 32 are examples of a first magnet and a second magnet according to the embodiment of the present invention, and the magnet group Mv1 is configured by the first magnet 30 and the second magnet 32.

The third magnet 34 and the fourth magnet 36 are examples of a third magnet and a fourth magnet according to the embodiment of the present invention, and the magnet group Mv4 is configured by the third magnet 34 and the fourth magnet 36.

The first magnet 30 and the third magnet 34 have S poles and N poles facing each other, and the second magnet 32 and the fourth magnet 36 have N poles and S poles facing each other.

In the shake correction device 10, the Hall element h1 is disposed inside the coil C1, and has the mounting surface 42 of the Hall element h1 at a position B between the first edge surface 38 and the second edge surface 40 that face each other in the height direction (the same direction as the A direction) of the coil C1.

In a case where the coil C1 is viewed from the A direction which is the height direction, the coil C1 is configured to have an elliptical shape (also referred to as an onshore truck shape) having a cavity portion inside. In the A direction, the Hall element h1 is disposed inside the coil C1. In addition, the Hall element h1 has a mounting surface 42 at a position B between the first edge surface 38 and the second edge surface 40 excluding the positions of the first edge surface 38 and the second edge surface 40.

The shake correction device 10 of the present embodiment includes the height adjustment portion 46 and the support member 44 in order to dispose the mounting surface 42 of the Hall element h1 at the position B.

Specifically, the Hall element h1 is mounted to the height adjustment portion 46 of which the height from the FPC substrate 28 is adjusted. The height adjustment portion 46 is a part of the FPC substrate 28 and is configured in a tongue-like or band-like shape as an example.

In addition, the height adjustment portion 46 is supported by the support member 44 on the FPC substrate 28. The support member 44 has a thickness in the A direction and is formed of, for example, a resin-molded member or an aluminum member. In a case where the height adjustment portion 46 itself has rigidity, the support member 44 is not necessary.

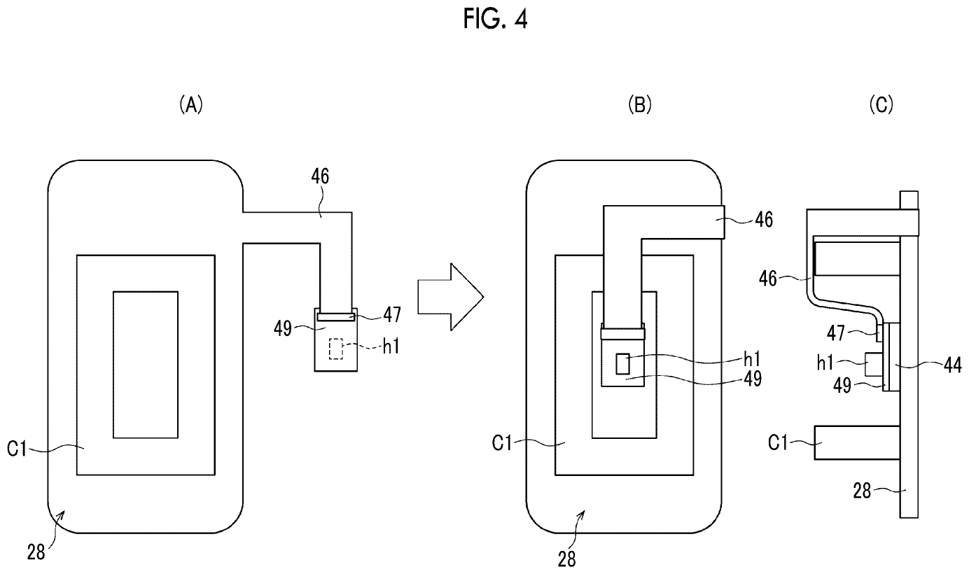

FIG. 4 is a schematic explanatory diagram showing a configuration (hereinafter, referred to as a substrate configuration) for disposing the mounting surface 42 of the Hall element h1 at the position B.

As shown in the plan view before assembly shown in (A) of FIG. 4, the Hall element h1 is mounted to a substantially L-shaped height adjustment portion 46 extending from the FPC substrate 28 via a connector 47.

As shown in the plan view and the side view after assembly shown in (B) and (C) of FIG. 4, the height adjustment portion 46 is folded and disposed inside the coil C1, and the substrate 49 of the Hall element h1 connected to the connector 47 is mounted to the FPC substrate 28 via the support member 44. In this manner, the substrate configuration of FIG. 3 can be obtained.

Next, a voice coil motor (VCM) that functions as an actuator driving the imaging element 20 will be described.

As shown in FIG. 3, the coil C1 is disposed at a position facing each of the magnet groups Mv1 and Mv4 in the A direction. Although not shown, similarly, the coil C2 is disposed at a position facing the magnet groups Mv2 and Mv5 in the A direction, and the coil C3 is disposed at a position facing the magnet groups Mv3 and Mv6.

The coil C1 and the magnet groups Mv1 and Mv4 constitute a VCM 1 for driving the X-axis. In a case where a PWM control signal (control current) having a predetermined frequency is output to the coil C1 from the driver 26 (see FIG. 2), the VCM 1 moves the moving portion 12 in the X direction by a Lorentz force generated between the coil C1 and the magnet groups Mv1 and Mv4.

The coil C2 and the magnet groups Mv2 and Mv5 constitute a VCM 2 (not shown). The VCM 2 and the VCM 1 constitute a VCM for rotational drive. The VCM for rotational drive rotates the moving portion 12 in the θ direction around the optical axis by Lorentz force generated between the coil C1 and the magnet groups Mv1 and Mv4 and Lorentz force generated between the coil C2 and the magnet groups Mv2 and Mv5 by setting directions of control currents flowing to the coil C1 and the coil C2 from the driver 26 to be opposite to each other.

The coil C3 and the magnet groups Mv3 and Mv6 constitute a VCM 3 (not shown) for the Y-axis drive. In a case where the PWM control signal (control current) having a predetermined frequency is output to the coil C3 from the driver 26, the VCM 3 moves the moving portion 12 in the Y direction by the Lorentz force generated between the coil C3 and the magnet groups Mv3 and Mv6.

The FPC substrate 28 (see FIG. 2) to which the coils C1, C2, and C3 are mounted has wiring line for driving the respective VCMs 1, 2, and 3. The FPC substrate 28 electrically connects the coils C1, C2, and C3 of the VCMs 1, 2, and 3 to a main substrate (not shown) of the shake correction device 10.

Next, a position detection module that functions as a position detection unit detecting the position of the imaging element 20 will be described. The position detection module includes Hall elements h1, h2, and h3 constituting the hall sensor.

The Hall element h1 outputs a signal corresponding to the magnetic field generated by the magnet groups Mv1 and Mv4, and the system control unit 24 detects the position of the moving portion 12 in the X direction by a change in the output of the signal.

The Hall element h2 outputs a signal corresponding to the magnetic field generated by the magnet groups Mv2 and Mv5, and the system control unit detects the position of the moving portion 12 in the X direction by a change in the output of the signal.

The system control unit 24 detects the rotation angle of the moving portion 12 about the optical axis as the position of the moving portion 12 in the θ direction by the change in the output signal of the Hall element h1 and the change in the output signal of the Hall element h2.

The Hall element h3 outputs a signal corresponding to the magnetic field generated by the magnet groups Mv3 and Mv6, and the system control unit 24 detects the position of the moving portion 12 in the Y direction. The above is the main configuration of the shake correction device 10 of the present embodiment.

Here, in the related art, an optical image stabilization (OIS) mechanism that drives a lens has been mainstream as a measure against image shake of a camera. However, in recent years, a camera that is equipped with an in-body image stabilization (IBIS) mechanism that drives an imaging element 20 to correct image shake has been increasing in order to improve the performance of the camera and reduce the overall size of a camera body and a lens portion. The IBIS is also employed in the shake correction device 10 of the present embodiment.

In the IBIS, a VCM is generally used as an actuator that drives the imaging element 20, and a Hall sensor is generally used as a position detection module that detects a position of the imaging element 20. The VCM is configured with a magnetic circuit including a coil, a magnet, and a yoke, and the hall sensor is configured with a magnetic circuit including a Hall element, a magnet, and a yoke.

As a configuration of the VCM, a one-side configuration in which two magnets (magnet groups) are disposed only in one of two yokes and a double magnet configuration (see FIG. 3) in which two magnets (magnet groups) are disposed in each of two yokes to increase a driving force are known.

In a case of the double magnet configuration, two magnets (first to fourth magnets) are disposed to face each other with the coil interposed therebetween. The double magnet configuration is also employed in the shake correction device 10 of the present embodiment.

### Comparative Example

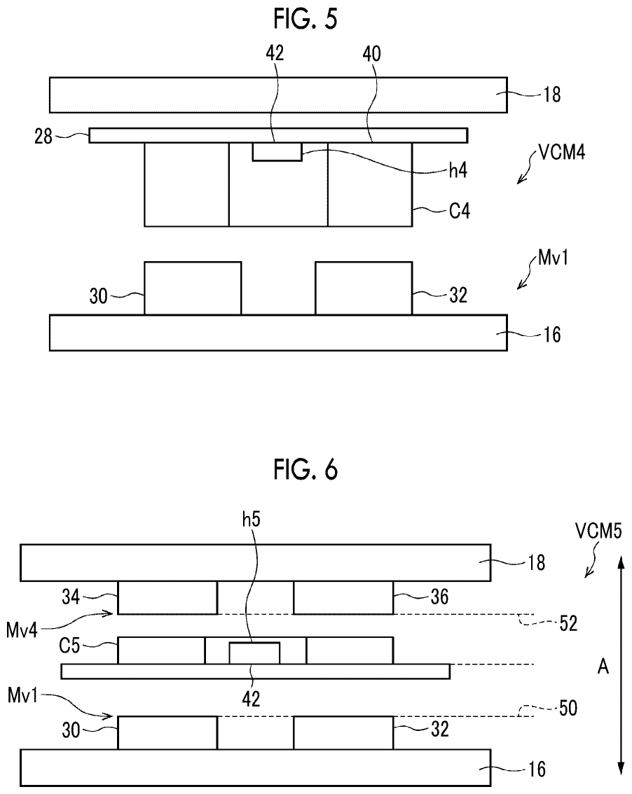

Hereinafter, some comparative examples will be described. In the VCMs 4, 5, and 6 of FIGS. 5 to 7, which will be described as comparative examples, the same or similar members as the VCM 1 of the shake correction device 10 shown in FIGS. 1 to 4 will be denoted by the same reference numerals.

FIG. 5 shows a VCM 4 having a one-side configuration. As in the VCM 4 shown in FIG. 5, the Hall element h4 is disposed inside the coil C4, so that the VCM 4 and the hall sensor are integrated to reduce the size of the IBIS.

In the hall sensor (position detection module) using the Hall element, the linearity characteristic that the change in the magnetic flux density on the surface of the Hall element with respect to the amount of change in the moving portion 12 (see FIG. 2) as the movable portion is linear is important for improving the position detection accuracy. Since the Hall element h4 of the VCM 4 in FIG. 5 is directly mounted to the FPC substrate 28, the mounting surface 42 of the Hall element h4 is provided on the same surface as the second edge surface 40 of the coil C4.

Here, in the VCM in which the Hall element is directly mounted to the FPC substrate and the VCM having a double magnet configuration, the following problems occur.

That is, in the VCM, in a case where the Hall element is disposed inside the coil, there is a problem that linearity characteristics are likely to deteriorate (robustness is low) due to a variation in a mounting position of the Hall element in the A direction (height direction) (for example, at which position of between the magnet group Mv1 and the magnet group Mv4 the mounting surface of the Hall element h1 is located).

Therefore, in the VCM 5 having the double magnet configuration shown in FIG. 6, in order to improve the linearity characteristic, the height of the coil C5 in the A direction is set to be lower than that of the coil C4 in FIG. 5, and the mounting surface 42 of the Hall element h5 is disposed at a position between the magnet surface 50 of the magnet group Mv1 and the magnet surface 52 of the magnet group Mv4.

However, in the VCM 5 shown in FIG. 6, since the coil C5 is small, a new problem arises in that a large driving force cannot be obtained. In recent years, imaging elements have been increased in size due to an increase in the number of pixels and an increase in image quality processing performance. Therefore, in order to effectively drive the IBIS, it is necessary to increase the driving force.

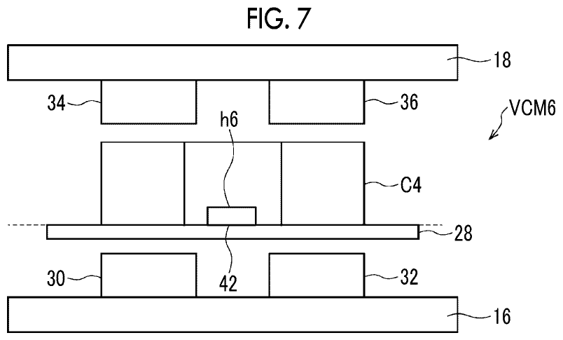

In a case where the coil C4 having a high height shown in FIG. 5 is applied instead of the coil C5 having a low height shown in FIG. 6 as in the VCM 6 shown in FIG. 7, a larger driving force than the VCM 5 shown in FIG. 6 can be obtained, but there is a problem in that it is difficult to improve the linearity characteristic because the Hall element h6 is directly mounted to the FPC substrate 28.

### Technology of Present Disclosure

Therefore, one technology of the present disclosure provides a shake correction device capable of improving linearity characteristics and obtaining a large driving force by solving each of a problem of deterioration of the linearity characteristics and a problem of a decrease in the driving force. Hereinafter, a configuration for solving the above-described problem will be described.

As shown in FIG. 3, the shake correction device 10 of the present embodiment comprises a moving portion 12 and a fixed portion 14. The fixed portion 14 includes a yoke 16 having a first magnet 30 and a second magnet 32, and a yoke 18 having a third magnet 34 and a fourth magnet 36. The moving portion 12 has an FPC substrate 28 to which the coil C1 and the Hall element h1 are mounted. As described above, the shake correction device 10 of the present embodiment employs the double magnet configuration.

In addition, the shake correction device 10 of the present embodiment is disposed such that the Hall element h1 is disposed inside the coil C1, and the mounting surface 42 of the Hall element h1 is provided at a position B between the first edge surface 38 and the second edge surface 40 facing each other in the height direction, which is the A direction of the coil C1.

With the shake correction device 10 having the above-described configuration, since the mounting surface 42 of the Hall element h1 is provided at the position B between the first edge surface 38 and the second edge surface 40 of the coil C1, it is possible to solve the problem of deterioration of the linearity characteristic. In addition, since a coil C1 (see FIGS. 5 and 7) having a high height can be applied as the coil, it is possible to solve the problem of the decrease in driving force. As a result, the shake correction device 10 of the present embodiment can improve the linearity characteristic and obtain a large driving force.

The position B of the mounting surface 42 for improving the linearity characteristic may be any position between the first edge surface 38 and the second edge surface 40 excluding the positions of the first edge surface 38 and the second edge surface 40, but an intermediate position between the first edge surface 38 and the second edge surface 40 is more preferable. In addition, it is more preferable that the light-receiving surface of the imaging element 20 is provided at an intermediate position between the first edge surface 38 and the second edge surface 40.

In the shake correction device 10 of the present embodiment, the Hall element h1 is mounted to the height adjustment portion 46 in which the height from the FPC substrate 28 is adjusted in order to dispose the mounting surface 42 of the Hall element h1 at the position B. With this configuration, the mounting surface 42 of the Hall element h1 can be easily disposed at the position B.

Hereinafter, some modification examples of the substrate configuration for disposing the mounting surface 42 of the Hall element h1 at the position B will be described. The same or similar members to the members shown in FIG. 4 will be denoted by the same reference numerals.

### First Modification Example of Substrate Configuration

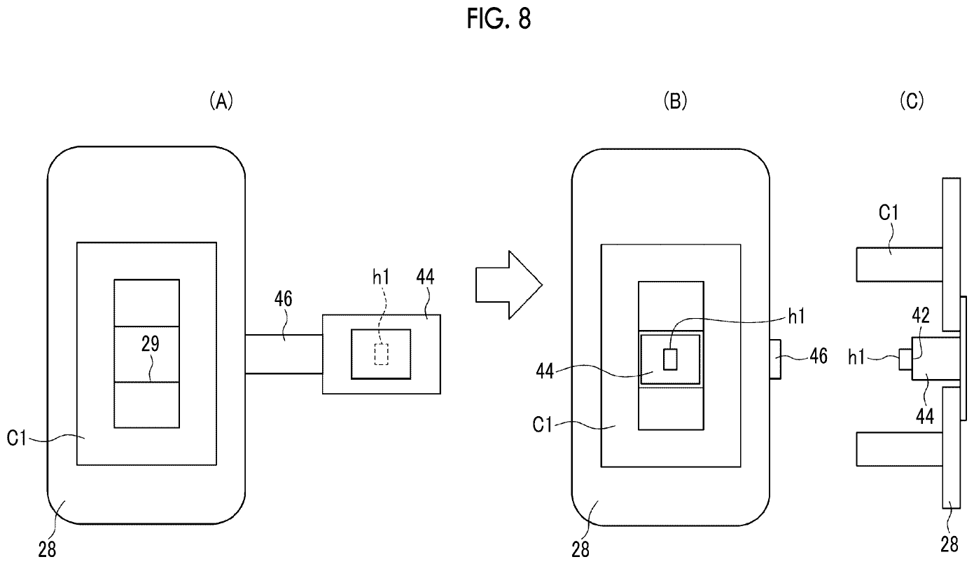

As shown in the plan view before assembly in (A) of FIG. 8, the FPC substrate 28 positioned inside the coil C1 has a rectangular opening portion 29. The height adjustment portion 46 extends laterally from the FPC substrate 28.

As shown in the plan view and the side view after the assembly shown in (B) and (C) of FIG. 8, the height adjustment portion 46 is folded to the back side of the FPC substrate 28, and the support member 44 is disposed to protrude from the opening portion 29 to the front side of the FPC substrate 28. As a result, the mounting surface 42 of the Hall element h1 can be disposed at the position B (see FIG. 3).

### Second Modification Example of Substrate Configuration

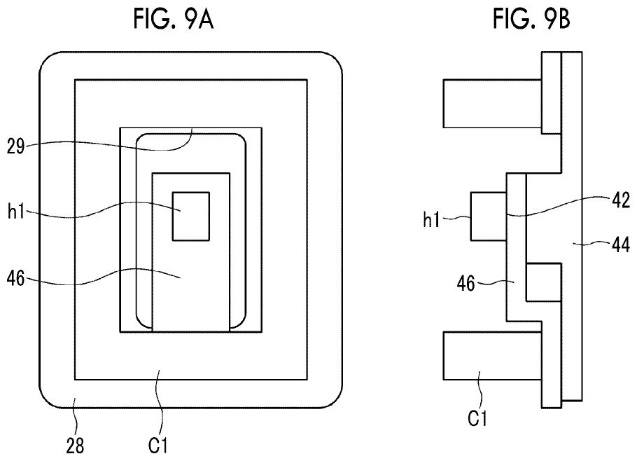

As in the plan view before assembly shown in FIG. 9A, the FPC substrate 28 positioned inside the coil C1 has a rectangular opening portion 29. In addition, the height adjustment portion 46 extends from the edge portion of the opening portion 29 toward the inside of the opening portion 29.

As shown in a side view after assembly in FIG. 9B, the height adjustment portion 46 is supported by the support member 44 from the back side of the FPC substrate 28. As a result, the mounting surface 42 of the Hall element h1 can be disposed at the position B (see FIG. 3).

### Third Modification Example of Substrate Configuration

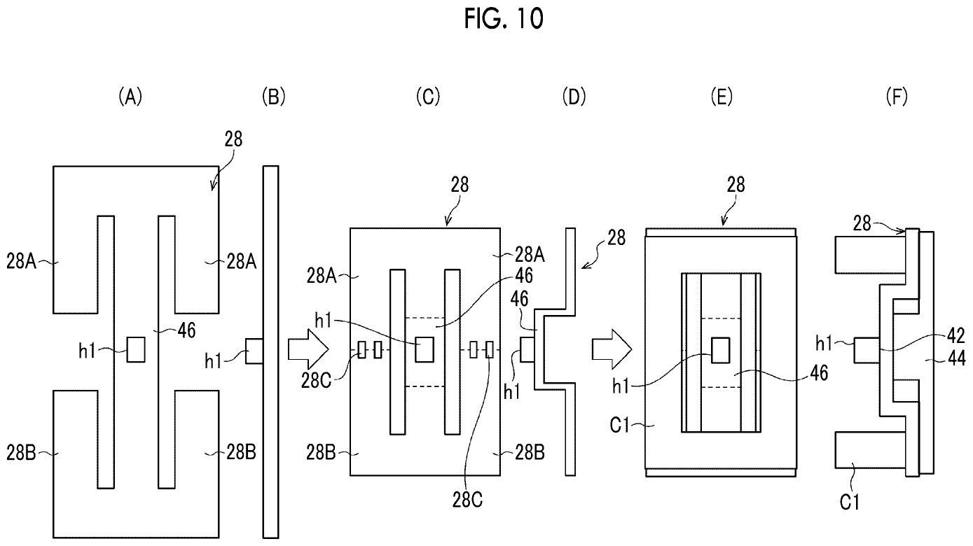

As shown in the plan view and the side view before assembly (in a component state) shown in (A) and (B) of FIG. 10, the FPC substrate 28 includes substrate pieces 28A and 28B spaced from each other on both sides, and a height adjustment portion 46 to which a Hall element h1 is mounted on the inside.

As shown in the plan view and the side view before assembly shown in (C) and (D) of FIG. 10, the respective substrate pieces 28A and 28B spaced from each other are connected to each other by the connecting member 28C, and thereby the height adjustment portion 46 having an excess length is bent to be convex toward the front side.

Next, as shown in the side views after assembly in (E) and (F) of FIG. 10, the coil C1 is mounted to the front side of the FPC substrate 28, and the height adjustment portion 46 is supported by the support member 44 from the back side of the FPC substrate 28. As a result, the mounting surface 42 of the Hall element h1 can be disposed at the position B (see FIG. 3).

### Fourth Modification Example of Substrate Configuration

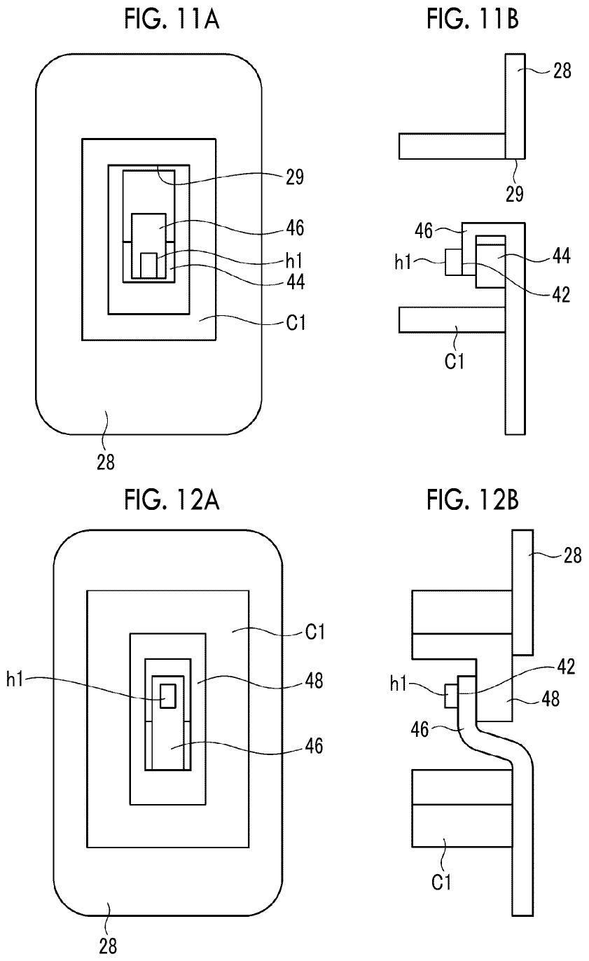

As shown in the plan view and the side view after assembly in FIGS. 11A and 11B, the FPC substrate 28 positioned inside the coil C1 has a rectangular opening portion 29. In addition, the height adjustment portion 46 extends from the edge portion of the opening portion 29 toward the inside of the opening portion 29, the height adjustment portion 46 is bent in an L-shape toward the front side of the FPC substrate 28, and the height adjustment portion 46 is supported by the support member 44. As a result, the mounting surface 42 of the Hall element h1 can be disposed at the position B (see FIG. 3).

### Fifth Modification Example of Substrate Configuration

As shown in the plan view and the side view after the assembly in FIGS. 12A and 12B, the height adjustment portion 46 is supported by the coil bobbin 48 on the FPC substrate 28, and the mounting surface 42 of the Hall element h1 is mounted to the height adjustment portion 46. Even in a case where the coil bobbin 48 is also used as the support member, the mounting surface 42 of the Hall element h1 can be easily disposed at the position B.

Hereinafter, some modification examples of the shake correction device according to the embodiment of the present invention will be described.

### First Modification Example of Shake Correction Device

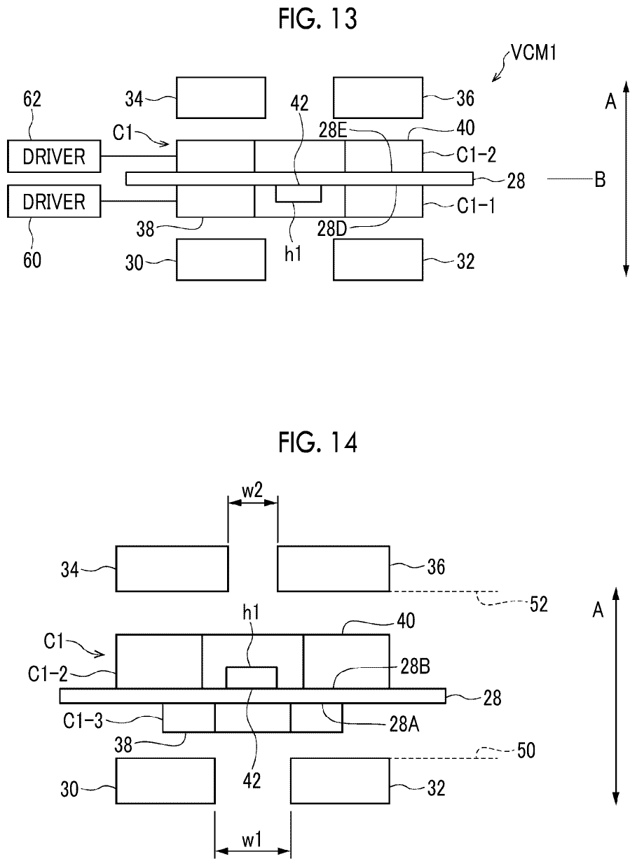

FIG. 13 shows a first modification example of the shake correction device (VCM1).

The coil C1 of the VCM 1 shown in FIG. 13 is divided into two parts, a first coil C1-1 and a second coil C1-2. The first coil C1-1 is disposed on a first surface 28D of the FPC substrate 28, and the second coil C1-2 is disposed on a second surface 28E of the FPC substrate 28, among the first surface 28D and the second surface 28E facing each other in the thickness direction of the FPC substrate 28 (the same as the A direction). In addition, the Hall element h1 is mounted to the first surface 28D. In FIG. 13, the yokes 16 and 18 are not shown.

As in the VCM 1 shown in FIG. 13, the first coil C1-1 and the second coil C1-2 are provided with the FPC substrate 28 interposed therebetween, and the Hall element h1 is mounted to the first surface 28D of the FPC substrate 28, whereby the mounting surface 42 of the Hall element h1 can be disposed at the position B between the first edge surface 38 and the second edge surface 40 of the coil C1.

As a result, even in the first modification example shown in FIG. 13, it is possible to improve the linearity characteristics and obtain a large driving force. The Hall element h1 may be mounted to the second surface 28E of the FPC substrate 28.

In addition, in the first modification example, it is preferable to comprise drivers 60 and 62 that output the first PWM control signal and the second PWM control signal, which are phase-shifted from each other at a predetermined frequency to the first coil C1-1 and the second coil C1-2.

In this way, by making the phases of the first PWM control signal and the second PWM control signal (driving frequency) different from each other, the beat noise on the imaging element 20 can be reduced. The first PWM control signal and the second PWM control signal are each an example of a first control signal and a second control signal of the embodiment of the present invention. In addition, the drivers 60 and 62 are an example of an electronic circuit according to the embodiment of the present invention.

### Second Modification Example of Shake Correction Device

FIG. 14 shows a second modification example of the shake correction device (VCM1).

Here, the difference between the VCM 1 shown in FIG. 13 and the VCM 1 of FIG. 14 is that the Hall element h1 is mounted to the second surface 28E of the FPC substrate 28 and the first coil C1-3 that is smaller (lower) than the first coil C1-1 in the A direction (height direction) is applied. In FIG. 14, the yokes 16 and 18 are also not shown.

As in the VCM 1 shown in FIG. 14, by disposing the Hall element h1 inside the second coil C1-2 and making the first coil C1-3 on the side on which the Hall element h1 is not disposed smaller than the second coil C1-2, it is possible to contribute to the reduction in size of the VCM 1.

In addition, in the VCM 1 of FIG. 14, an example in which the Hall element h1 is mounted to the second surface 28E of the FPC substrate 28 is shown, but the Hall element h1 may be mounted to the first surface 28D. In this case, a second coil smaller than the first coil C1-1 may be applied as the second coil C1-2.

In addition, in the VCM 1 of FIG. 14, the inner diameter of the first coil C1-3 is configured to be smaller than the inner diameter of the second coil C1-2. In addition, the outer shape of the first coil C1-3 is configured to be smaller than the outer shape of the second coil C1-2. Accordingly, it is possible to contribute to the size reduction of the VCM 1. The inner diameter refers to a minor axis and a major axis of an ellipse.

In addition, in a case where the inner diameter of the first coil C1-3 is smaller than the inner diameter of the second coil C1-2 and the outer shape of the first coil C1-3 is equal to the outer shape of the second coil C1-2, a large driving force can be obtained.

In addition, as in the VCM 1 of FIG. 14, it is preferable that the first to fourth magnets 30 to 36 are disposed such that the first width w1 and the second width w2 are different from each other.

That is, as in the VCM 1 of FIG. 14, in a case where the Hall element h1 is disposed inside the coil C1 of the VCM 1 having the double magnet configuration, the first to fourth magnets 30 to 36 are disposed such that the first width w1 and the second width w2 are different from each other (for example, the first width w1>the second width w2). Since the first width w1 and the second width w2 are different from each other, the magnetic flux between the magnets 34 and 36 and the magnets 30 and 32 is bent, and as a result, the linearity characteristic is improved. The relationship between the magnitude of the first width w1 and the magnitude of the second width w2 may be the first width w1<the second width w2.

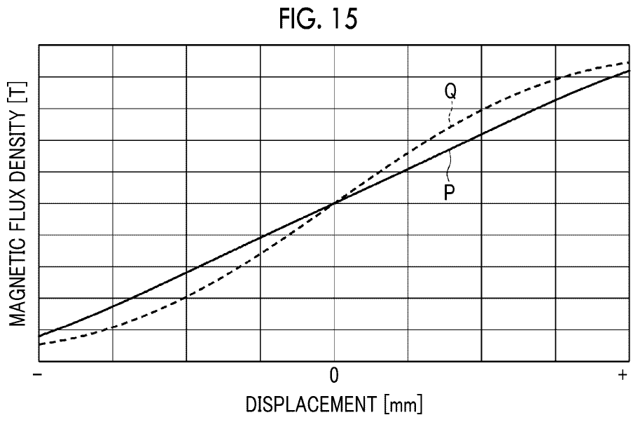

FIG. 15 is a graph showing a relationship between the double magnet configuration and the linearity characteristic. The vertical axis of the graph indicates the magnetic flux density [T], and the horizontal axis indicates the displacement [mm] of the Hall element.

A solid line P of the graph of FIG. 15 shows the linearity characteristic obtained by the VCM1 having the configuration (for example, the first width w1>the second width w2) shown in FIG. 14, and a broken line Q of the graph shows the linearity characteristic obtained by the VCM having the configuration of the first width w1=the second width w2.

As shown in FIG. 15, with the VCM1 having the configuration shown in FIG. 14, the linearity characteristic can be improved as compared with the VCM having the configuration of the first width w2=the second width w2.

In addition, in the configuration of the VCM 1 in FIG. 14, by disposing the Hall element h1 in the vicinity of the middle between the magnet surface 50 and the magnet surface 52 in the A direction, the robustness of the linearity characteristic with respect to the height variation of the Hall element h1 is improved.

In addition, in the VCM 1 of FIG. 14, the coil C1 is divided and disposed on both surfaces (the first surface 28D and the second surface 28E) of the FPC substrate 28, so that the Hall element h1 can be disposed in the vicinity of the middle between the magnet surface 50 and the magnet surface 52 without reducing the driving force of the VCM 1.

The above example in which the first width w1 and the second width w2 are different is applied to the VCM 1 of FIG. 14, but the present example can also be applied to the VCM 1 of FIG. 13 comprising the first coil C1-1 and the second coil C1-2 having the same size.

In addition, in the above-described examples, the example in which the shake correction device (position control device) according to the embodiment of the present invention is applied to the IBIS has been described, but the shake correction device according to the embodiment of the present invention can also be applied to the OIS. In this case, the optical device comprising the shake correction device is a lens.

Although the shake correction device according to the present embodiment has been described above, the present invention may be subjected to some improvements or modifications without departing from the scope of the present invention.

### EXPLANATION OF REFERENCES

10: shake correction device
13: holding member
12: moving portion
14: fixed portion
16: yoke
18: yoke
20: imaging element
22: circuit board
C1: coil
C2: coil
C3: coil
h1: Hall element
h2: Hall element
h3: Hall element
24: system control unit
26: driver
28: FPC substrate
28A: substrate piece
28B: substrate piece
28C: connecting member
28D: first surface
28E: second surface
29: opening portion
30: first magnet
32: second magnet
34: third magnet
36: fourth magnet
Mv1: magnet group
Mv2: magnet group
Mv3: magnet group
Mv4: magnet group
Mv5: magnet group
Mv6: magnet group
38: first edge surface
40: second edge surface
42: mounting surface
44: support member
46: height adjustment portion
47: connector
48: coil bobbin
49: substrate
50: magnet surface
52: magnet surface
60: driver
62: driver

What is claimed is:

1. A position control device comprising:
a fixed portion that includes
a first yoke,
a first magnet and a second magnet that are provided on the first yoke and are disposed with a first width,
a second yoke that is disposed to face the first yoke, and
a third magnet and a fourth magnet that are provided on the second yoke and are disposed with a second width; and
a moving portion that is disposed between the first yoke and the second yoke and has a substrate on which a coil and a position detection sensor are mounted,
wherein the position detection sensor is disposed inside the coil and has a mounting surface of the position detection sensor at a position between a first edge surface and a second edge surface that face each other in a height direction of the coil.

2. The position control device according to claim 1,
wherein the position detection sensor is mounted to a height adjustment portion of which a height from the substrate is adjusted.

3. The position control device according to claim 2, further comprising:
a support member that supports the height adjustment portion.

4. The position control device according to claim 3,
wherein the support member is a coil bobbin of the coil.

5. The position control device according to claim 1,
wherein the coil includes a first coil disposed on a first surface and a second coil disposed on a second surface, the first surface and the second surface facing each other in a thickness direction of the substrate, and
the position detection sensor is mounted to the first surface or the second surface.

6. The position control device according to claim 5, further comprising:
an electronic circuit that outputs a first control signal and a second control signal, which are phase-shifted from each other at a predetermined frequency to the first coil and the second coil.

7. The position control device according to claim 6,
wherein the first control signal and the second control signal are PWM control signals.

8. The position control device according to claim 5,
wherein, in a case where the position detection sensor is mounted to the first surface, an inner diameter of the second coil is smaller than an inner diameter of the first coil.

9. The position control device according to claim 1,
wherein the first width and the second width are different from each other.

10. A shake correction device,
wherein the position control device according to claim 1 is a shake correction device,
the moving portion includes a holding member, and
the holding member holds an imaging element or an optical element.

11. An optical device comprising:
the shake correction device according to claim 10.
